(19) United States
(12) Patent Application Publication
(10) Pub. No.: US 2025/0325445 A1
(43) Pub. Date: Oct. 23, 2025

(54) SYSTEMS AND METHODS FOR ACUPUNCTURE OF THE HEAD

(71) Applicant: Myung Chil Kim, Oklahoma City, OK (US)

(72) Inventor: Myung Chil Kim, Oklahoma City, OK (US)

(21) Appl. No.: 19/026,125

(22) Filed: Jan. 16, 2025

Related U.S. Application Data
(60) Provisional application No. 63/621,122, filed on Jan. 16, 2024.

(51) Int. Cl. A61H 39/06; A42B 3/04; A61H 39/08

(52) U.S. Cl. CPC A61H 39/06; A42B 3/0406; A61H 39/086; A61H 2201/0207; A61H 2201/0221; A61H 2201/025; A61H 2201/0278; A61H 2201/1604; A61H 2201/165

(57) ABSTRACT

Provided is a system used for acupuncture treatment, including a helmet that includes: a base having at least one hole positioned at strategically designated acupuncture points; at least one object placed within the at least one hole; and a heat source, wherein the heat source is configured to heat up the at least one object for acupuncture treatment. Also provided is a method for acupuncture treatment including: configuring at least one strategically placed hole in a helmet according to specific acupuncture points; having a patient wear the helmet snugly; inserting at least one object into the at least one strategically placed hole; heating up the at least one object with a heat source; and administering heat-based acupuncture treatment to the patient via the heated up at least one object through the at least one strategically placed hole.

### CROSS REFERENCE TO RELATED APPLICATIONS

This application claims the benefit of U.S. Provisional Application Ser. No. 63/621,122, filed Jan. 16, 2024, and entitled “FIRE-PREVENTION HELMET FOR ACUPUNCTURE OF THE HEAD” the entirety of which is herein incorporated by reference.

### TECHNICAL FIELD

The present disclosure generally relates to acupuncture and accessories to carry out or to be used with acupuncture, particularly systems to be used with, or headwear or headgear to be worn during acupuncture processes, methods or treatments or to facilitate such acupuncture processes, methods or treatments.

### BACKGROUND

Ever since humanity has existed, blood has pumped from the human heart to the head, legs and feet, and it has returned to the heart as part of the circulatory system. Blood circulation is made more difficult because of gravity. Certain acupuncture techniques have been developed to help overcome these difficulties.

One such technique is to warm the tip of the acupuncture needle with a hair dryer. Heating up the acupuncture needle while the needle is inserted in the body enhances the efficacy of the treatment under oriental medicine techniques. This technique of using a hair dryer to warm the acupuncture needles can be used quite readily on most parts of the body. Heat from a heat setting hair dryer is the safest method for warming up the needles. However, since hair is covering the scalp, there is not a device or structure that can be used with these heated needles. Hence, there is a need for a convenient device or structure to allow practitioners to use heated needles safely on a patient's head. There also exists a need for an improved method of using an acupuncture technique on a patient's head to improve safety and efficiency of treatment methods.

### SUMMARY

Provided is a helmet for acupuncture point areas that helps guide the licensed acupuncturest oriental medicine doctor to perform acupuncture treatment on a patient's head through the use of heated needles. If a client is averse to using needles, then a helmet with stationary nuts and bolts can be used instead. The helmet can also have attached rubber band clip holding each side of the helmet with the extended sides on each side for more security. A torch fire can be used to warm up the needles or the nuts and bolts.

According to an aspect of the disclosure, a laser pointed to the needles is another safe technique to warm the needles up. According to an aspect of the disclosure, a lamp can also be used to generate heat. According to an aspect of the disclosure, a standing hair dryer (e.g., a professional hooded floor hair dryer) can be used to generate electric heat and hot air on the needles. According to an aspect of the disclosure, a portable electric or battery generated heat lamp or stationary heat lamp can also be used.

According to an aspect of the disclosure, only the head area needs to be heated, not the entire body for this disclosed technique.

According to an aspect of the disclosure, there are slits on the sides of the helmet for ventilation.

Provided is a system used for acupuncture treatment, including a helmet that includes: a base having at least one hole positioned at strategically designated acupuncture points; at least one object placed within the at least one hole; and a heat source, wherein the heat source is configured to heat up the at least one object for acupuncture treatment. Also provided is a method for acupuncture treatment including: configuring at least one strategically placed hole in a helmet according to specific acupuncture points; having a patient wear the helmet snugly; inserting at least one object into the at least one strategically placed hole; heating up the at least one object with a heat source; and administering heat-based acupuncture treatment to the patient via the heated up at least one object through the at least one strategically placed hole.

Other objects and advantages of the present disclosure will become obvious to the reader and it is intended that these objects and advantages are within the scope of the present disclosure. To the accomplishment of the above and related objects, this disclosure may be embodied in the form illustrated in the accompanying drawings, attention being called to the fact, however, that the drawings are illustrative only, and that changes may be made in the specific construction illustrated and described within the scope of this application.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following description taken in conjunction with the accompanying drawings.

FIG. 1 is a front view of an embodiment of the present disclosure as worn by the user during a treatment session and using a heat source.

FIG. 2 is a side view of an embodiment the present disclosure viewed from the patient's left side.

FIG. 3 is a side view of an embodiment of the present disclosure viewed from the patient's right side.

FIG. 4 is a rear view of an embodiment of the present disclosure viewed from the patient's back side.

FIG. 5 is a front view of an embodiment of the present disclosure viewed from the patient's front side.

FIG. 6 is a top view of an embodiment of the present disclosure with the top and sides visible which shows the hold patterns.

FIG. 7 is a front view of an embodiment of the present disclosure showing one embodiment of the hole patterns using bolts and nuts.

FIG. 8 is a top view of an embodiment of the present disclosure.

FIG. 9 is a rear view of an embodiment of the present disclosure.

FIG. 10 is a left view of an embodiment of the present disclosure.

FIG. 11 is a right view of an embodiment of the present disclosure.

FIG. 12 is a top view of an embodiment of the present disclosure with particular dimensions.

FIG. 13 is a front view of an embodiment of the present disclosure showing an extended helmet.

FIG. 14 is a side view of an embodiment of the present disclosure showing an extended helmet.

Example embodiments will become more fully understood from the detailed description given herein below and the accompanying drawings, wherein like elements are represented by like reference characters, which are given by way of illustration only and thus are not limitative of the example embodiments herein.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent to those skilled in the art, however, that these concepts may be practiced without these specific details. In some instances, well-known structures and components are shown in block diagram form in order to avoid obscuring such concepts. As described herein, the use of the term “and/or” is intended to represent an “inclusive OR”, and the use of the term “or” is intended to represent an “exclusive OR”.

The present disclosure is directed to a helmet for acupuncture point areas that helps guide the licensed acupuncturest oriental medicine doctor to perform acupuncture treatment on a patient's head through the use of heated needles. If a client is averse to using needles, then a helmet with stationary nuts and bolts can be used instead. The helmet can also have attached rubber band clip holding each side of the helmet with the extended sides on each side for more security. A torch fire can be used to warm up the needles or the nuts and bolts.

According to an aspect of the disclosure, a laser pointed to the needles is another safe technique to warm the needles up. According to an aspect of the disclosure, a lamp can also be used to generate heat. According to an aspect of the disclosure, a standing hair dryer (e.g., a professional hooded floor hair dryer) can be used to generate electric heat and hot air on the needles. According to an aspect of the disclosure, a portable electric or battery generated heat lamp can also be used.

According to an aspect of the disclosure, only the head area needs to be heated, not the entire body for this disclosed technique.

According to an aspect of the disclosure, there are slits on the sides of the helmet for ventilation.

Reference is made now herein to the attached drawings. For the purposes of presenting a brief and clear description of the present disclosure, one or more preferred embodiments will be discussed.

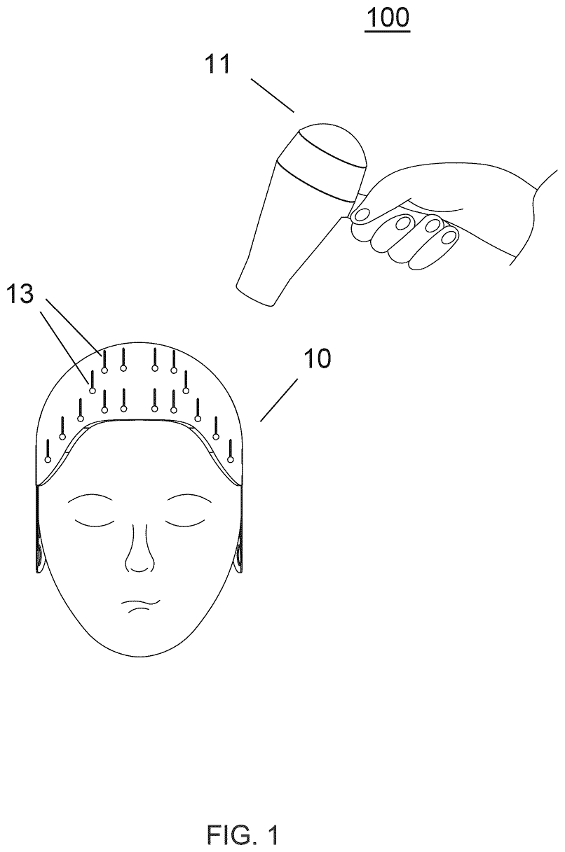

FIG. 1 is a front view 100 of an embodiment of the present disclosure, specifically a helmet 10, as worn by the user during a treatment session and using a heat source 11.

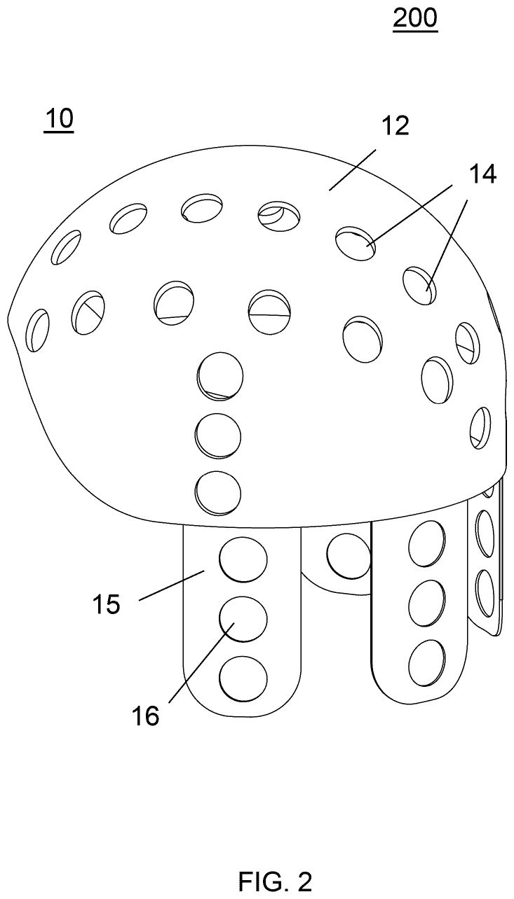

Turning now to FIG. 1, front view 100 shows that the present disclosure provides a helmet 10 designed to be worn on a patient's head to prevent burns or singeing of hair during an acupuncture treatment using heat-based methods from a heat source 11, which heats up the helmet 10 as well as acupuncture needles 13. The helmet 10 shields the patient's head and hair while allowing for controlled application of heat therapy from a heat source 11 to acupuncture needles 13 placed into the scalp via holes 14 (shown in FIGS. 2-14). The helmet 10 is further designed to be lightweight and comfortable for patients to wear.

Heat source 11 is shown as a hair dryer, but is not limited to being a hair dryer. An example hair dryer can include a portable hair dryer that is electronic with a heat setting, a standing hair dryer (e.g., a professional hooded floor hair dryer) or any other similar hair dryer that can be used to generate electric heat and hot air on the needles 13. According to an aspect of the disclosure, heat source 11 can be a laser pointed to the needles 13 to provide a safe technique to warm the needles 13 up. According to an aspect of the disclosure, heat source 11 may also be a lamp that can also be used to generate heat onto the needles 13. According to an aspect of the disclosure, and as discussed above, heat source 11 may be a standing hair dryer (e.g., a professional hooded floor hair dryer) that can be used to generate electric heat and hot air on the needles 13. According to an aspect of the disclosure, heat source 11 can be a portable electric or battery generated heat lamp or a stationary heat lamp that can also be used to provide heat to the needles 13.

According to an aspect of the disclosure, only the head area needs to be heated by helmet 10, not the entire body for this disclosed set-up shown in FIG. 1.

According to an aspect of the disclosure, there are slits on the sides of the helmet (not shown but can be more clearly imagined in the side views of FIGS. 2-4, 11 & 14) for ventilation.

According to an aspect of the disclosure, the helmet 10 (also later discussed as the material making up the base 12) can be made of materials including plastics, thermoplastics, fiberglass, Kevlar, carbon fiber, composite blends of these prior listed materials and other similar materials. The material of the helmet 10 can also be constructed from a heat-retaining material, such as metal. Metal, such as aluminum, copper, silver, or gold, is the presently preferred material due to the fact that metal collects and conducts electromagnetic material more effectively. However, as discussed above, the material of the helmet 10 may be constructed from any suitable material, such as plastic, or silicone, or in alternative embodiment consistent with the present disclosure. Such material should be heat-dissipating protect the scalp from direct heat exposure while allowing heat to penetrate effectively.

According to an aspect of the disclosure, the needles 13 made be made of materials including thermoplastics, plastics, metal, carbon fiber, composite blends of these prior listed materials and other similar materials. The surface of the needles 13 may also be coated in silicone.

FIG. 2 is a side view 200 of an embodiment the present disclosure viewed from the patient's left side.

Turning now to FIG. 2, a side view 200 of the helmet 10 (initially shown in FIG. 1) is provided, the helmet 10 including a head-conforming base 12 that rests comfortably on the patient's head. The helmet 10 has holes 14 through which acupuncture needle 13 (shown in FIG. 1) can be passed into the patient's scalp. All the holes 14 allow acupuncture treatment on the top of head area by being located in acupuncture points, hence heated needles 13 are able to pass through the holes 14 in order to directly be inserted into predetermined acupuncture points.

According to an aspect of the disclosure, the head-confirming base 12 or base 12 of the helmet 10 made be made of materials including plastic, thermoplastics, fiberglass, Kevlar, carbon fiber, composite blends of these prior listed materials and other similar materials. The base 12 can also be constructed from a heat-retaining material, such as metal. Metal, such as aluminum, copper, silver, or gold, is the presently preferred material due to the fact that metal collects and conducts electromagnetic material more effectively. However, as discussed above, the base 12 may be constructed from any suitable material, such as plastic, or silicone, or in alternative embodiment consistent with the present disclosure. Such material should be heat-dissipating protect the scalp from direct heat exposure while allowing heat to penetrate effectively.

Also shown are flaps 15 attached to the helmet 16, the flaps 15 containing flap holes 16. The flaps 15 may be configured to provide better fits on the heads of patients, or improved ventilation, or can even provide aesthetic improvements to the overall design of helmet 10. The flap holes 16 can also function as the holes 14 described above, but can also be used to provide a better or more snug fit of the helmet, by e.g., providing a way to fit in straps and other securing methods.

According to an aspect of the disclosure, the flaps 15 may be made of material including thermoplastics, fiberglass, Kevlar, carbon fiber, composite blends of these prior listed materials and other similar materials.

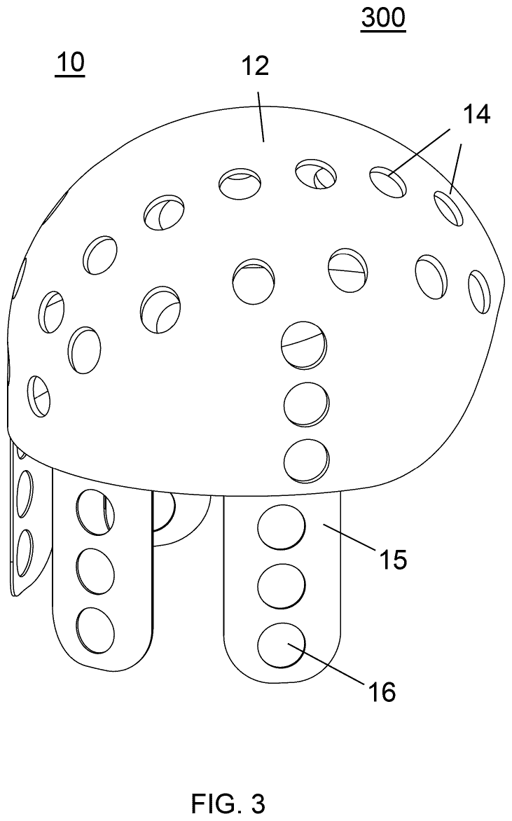

FIG. 3 is a side view 300 of an embodiment of the present disclosure viewed from the patient's right side.

Turning now to FIG. 3, a side view 300 of the helmet 10 (initially shown in FIG. 1) is provided, the helmet 10 including a head-conforming base 12 that rests comfortably on the patient's head. The helmet 10 has holes 14 through which acupuncture needle 13 (shown in FIG. 1) can be passed into the patient's scalp. All the holes 14 allow acupuncture treatment on the top of head area by being located in acupuncture points, hence heated needles 13 are able to pass through the holes 14 in order to directly be inserted into predetermined acupuncture points. The helmet 10 is further designed to be lightweight and comfortable for patients to wear. Moreover, similar to FIG. 2, flaps 15 and flap holes 16 are shown. Discussion of all the relevant components 10, 12, 14, 15 and 16 can also be found above for FIG. 2.

In FIGS. 1-3, the views 100, 200 & 300 shows an exemplary pattern in which the holes 14 can be arranged in, but this arrangement is not limited to the arrangement that is shown in FIGS. 1-3, and can be any desired arrangement, especially one that provides improved or optimal heat-based acupuncture treatment to patients.

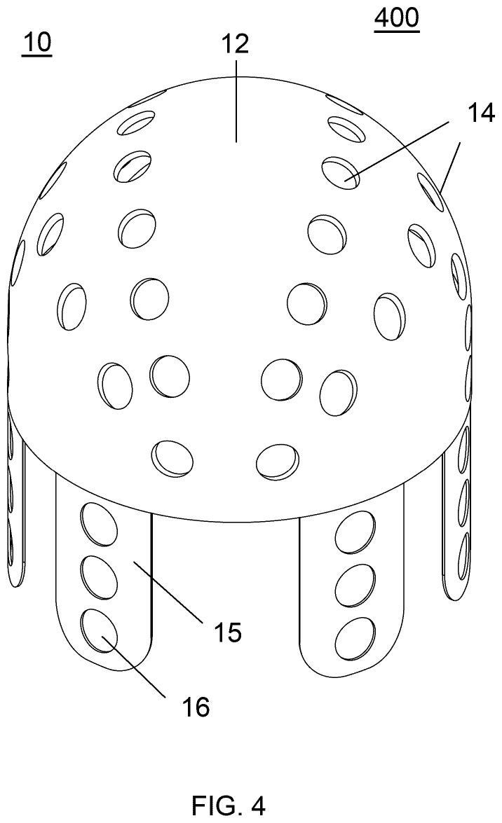

FIG. 4 is a rear view 400 of an embodiment of the present disclosure viewed from the patient's back side.

Turning now to FIG. 4, a rear view 400 of the helmet 10 (initially shown in FIG. 1) is provided, the helmet 10 including a head-conforming base 12 that rests comfortably on the patient's head. The helmet 10 has holes 14 through which acupuncture needle 13 (shown in FIG. 1) can be passed into the patient's scalp. All the holes 14 allow acupuncture treatment on the top of head area by being located in acupuncture points, hence heated needles 13 are able to pass through the holes 14 in order to directly be inserted into predetermined acupuncture points. The helmet 10 is further designed to be lightweight and comfortable for patients to wear. Moreover, similar to FIG. 2, flaps 15 and flap holes 16 are shown. Discussion of all the relevant components 10, 12, 14, 15 and 16 can also be found above for FIG. 2.

In FIG. 4, the rear view 400 shows an exemplary pattern in which the holes 14 can be arranged in, but this arrangement is not limited to the arrangement that is shown in FIG. 4, and can be any desired arrangement, especially one that provides improved or optimal heat-based acupuncture treatment to patients.

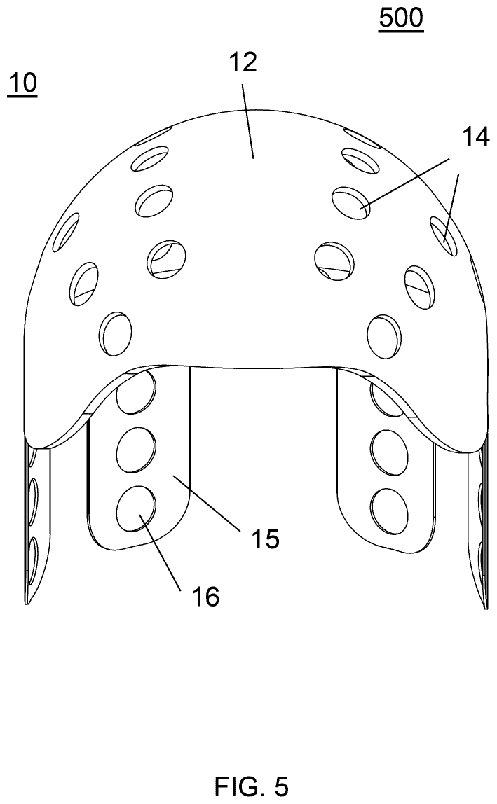

FIG. 5 is a front view 500 of an embodiment of the present disclosure viewed from the patient's front side.

Turning now to FIG. 5, a rear view 500 of the helmet 10 (initially shown in FIG. 1) is provided, the helmet 10 including a head-conforming base 12 that rests comfortably on the patient's head. The helmet 10 has holes 14 through which acupuncture needle 13 (shown in FIG. 1) can be passed into the patient's scalp. All the holes 14 allow acupuncture treatment on the top of head area by being located in acupuncture points, hence heated needles 13 are able to pass through the holes 14 in order to directly be inserted into predetermined acupuncture points. The helmet 10 is further designed to be lightweight and comfortable for patients to wear. Moreover, similar to FIG. 2, flaps 15 and flap holes 16 are shown. Discussion of all the relevant components 10, 12, 14, 15 and 16 can also be found above for FIG. 2.

In FIG. 5, the rear view 500 shows an exemplary pattern in which the holes 14 can be arranged in, but this arrangement is not limited to the arrangement that is shown in FIG. 5, and can be any desired arrangement, especially one that provides improved or optimal heat-based acupuncture treatment to patients.

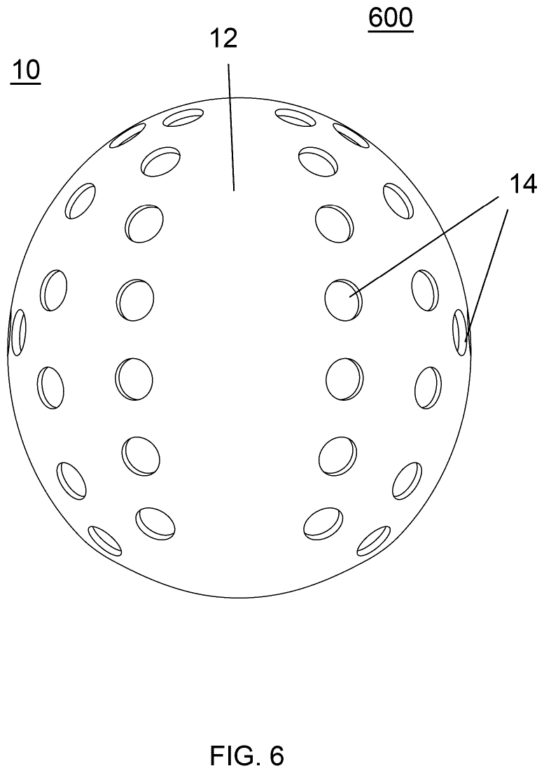

FIG. 6 is a top view 600 of an embodiment of the present disclosure with the top and sides visible which shows the hold patterns.

Turning now to FIG. 6, a top view 600 of the helmet 10 (initially shown in FIG. 1) is provided, the helmet 10 including a head-conforming base 12 that rests comfortably on the patient's head. The helmet 10 has holes 14 through which acupuncture needle 13 (shown in FIG. 1) can be passed into the patient's scalp. All the holes 14 allow acupuncture treatment on the top of head area by being located in acupuncture points, hence heated needles 13 are able to pass through the holes 14 in order to directly be inserted into predetermined acupuncture points. The helmet 10 is further designed to be lightweight and comfortable for patients to wear. Discussion of all the relevant components 10, 12 & 14 can also be found above for FIG. 2.

In FIG. 6, the rear view 600 shows an exemplary pattern in which the holes 14 can be arranged in, but this arrangement is not limited to the arrangement that is shown in FIG. 6, and can be any desired arrangement, especially one that provides improved or optimal heat-based acupuncture treatment to patients.

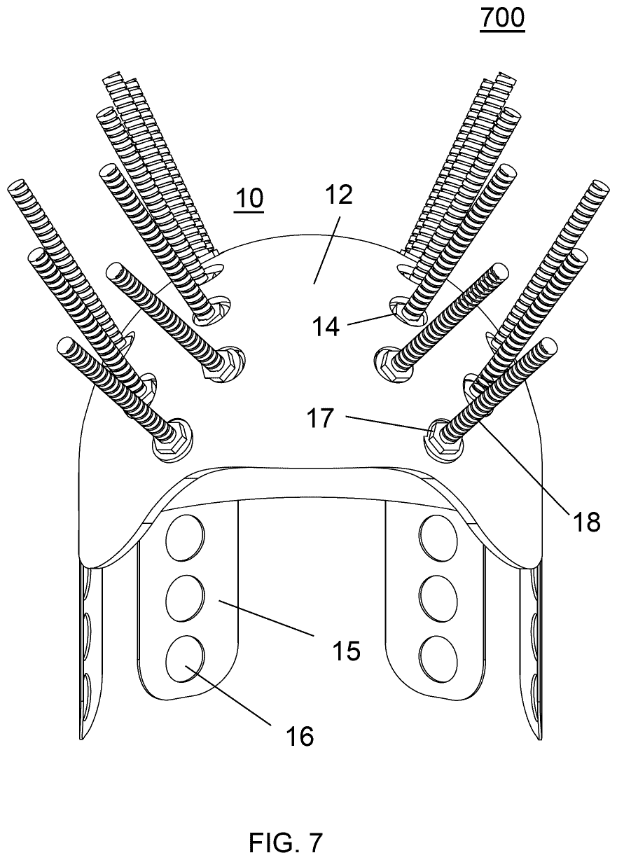

FIG. 7 is a front view 700 of an embodiment of the present disclosure showing one embodiment of the hole patterns using bolts 18 and nuts 17.

Turning now to FIG. 7, a front view 700 of the helmet 10 (initially shown in FIG. 1) is provided, the helmet 10 including a head-conforming base 12 that rests comfortably on the patient's head. The helmet 10 has holes 14 through which a screw set—making up nuts 17 and bolts 18—can be passed into the patient's scalp. All the holes 14 allow acupuncture treatment on the top of head area by being located in acupuncture points, hence heated nuts 17 and bolts 18 are able to pass through the holes 14 in order to directly be inserted into predetermined acupuncture points. The helmet 10 is further designed to be lightweight and comfortable for patients to wear. Moreover, similar to FIG. 2, flaps 15 and flap holes 16 are shown. Discussion of all the relevant components 10, 12, 14, 15 and 16 can also be found above for FIG. 2.

For the nuts 17 and bolts 18 shown in FIG. 7 and front view 700, a treatment known as moxibustion, or “moxa treatment”—a traditional Chinese medicinal therapy which consists of burning dried mugwort on particular points of the body, usually by grinding the mugwort into a fluff or configuring it into a cigar-shaped stick—can be enhanced and improved, by means of using the nuts 17 and bolts 18. Specifically, the nuts 17 and bolts 18 provides airs to the holes 14 for allowing moxa treatment to be performed. This non-needle approach of using nuts 17 and bolts 18 to perform moxa treatment offers many advantages, the chief of which is avoiding the use of needles for patients that fear needles.

More specifically, by strategically positioning screw points where the holes 14 and specific acupuncture points (or acupoints) are and having the nuts 17 and bolts 18 be positioned up against the patient's head in those locations on the inner surface of the helmet, many advantages arise. For example, more specific targeting of conditions such as headaches, migraines, neck pain and other symptoms can be precisely addressed. Another advantage is that individual patient anatomy can be honed in on, and patients are given autonomy and freedom of choice with respect to needle-based or non-needle based treatment. For utilizing nuts 17 and bolts 18, different treatment durations and frequencies may need to be adjusted based on the screw material, size, and desired level of heat penetration.

Further advantages of the non-needle based treatment approach from using nuts 17 and bolts 18 include: needle-free pain relief, in that the key advantage of providing a needle-free alternative for acupoint stimulation may be preferred by patients, and there is a stronger potential appeal to individuals or potential patients with a fear of needles. Moreover, improved patient compliance occurs because this non-needle based treatment enhanced patient compliance with acupuncture treatments due to its convenience and ease-of-use. Safety advantages occur such as avoiding the pricking or accidental exposure to acupuncture needles by avoiding the use of needles entirely.

For using nuts 17 and bolts 18, it is very important to select safe and biocompatible materials for them. Hence, according to an aspect of the present disclosure, the materials making up the nuts 17 and bolts 18 can include plastic, polymer, PEEK (polyetheretherketone), steel, titanium and other similar bio-compatible materials offered by the company High Performance Polymer on the page of “Bio-Compatible Screws, Nuts, Bolts, Washers, and Fasteners” at the specific retail URL website of: https://highperformancepolymer.co.uk/collections/bio-compatible-screws-nuts-bolts-washers-and-fasteners.

The temperature of the nuts 17 and bolts 18 can be monitored during acupuncture treatment in order to prevent overheating or heat discomfort from occurring to the actual patient.

Moreover, the bolt's head or head of the bolt 18 can be inside the helmet 10 and the nut 17 can be outside the helmet 10 in order to provide for the most secure configuration, snug or tightest fit for the patient and optimal treatment results,

The approach of using nuts 17 and bolts 18 is novel and non-obvious because there is nothing in the prior art that discloses, either alone or in combination, the performance of moxa treatment with a helmet using an embedded screw system for acupoint simulation. As a result, this nuts 17 and bolts 18 approach offers a unique and potentially groundbreaking approach to pain management, especially without the use of needles or acupuncture needles.

In FIG. 7, the front view 700 shows an exemplary pattern in which the holes 14 can be arranged in, but this arrangement is not limited to the arrangement that is shown in FIG. 7, and can be any desired arrangement, especially one that provides improved or optimal heat-based acupuncture treatment to patients.

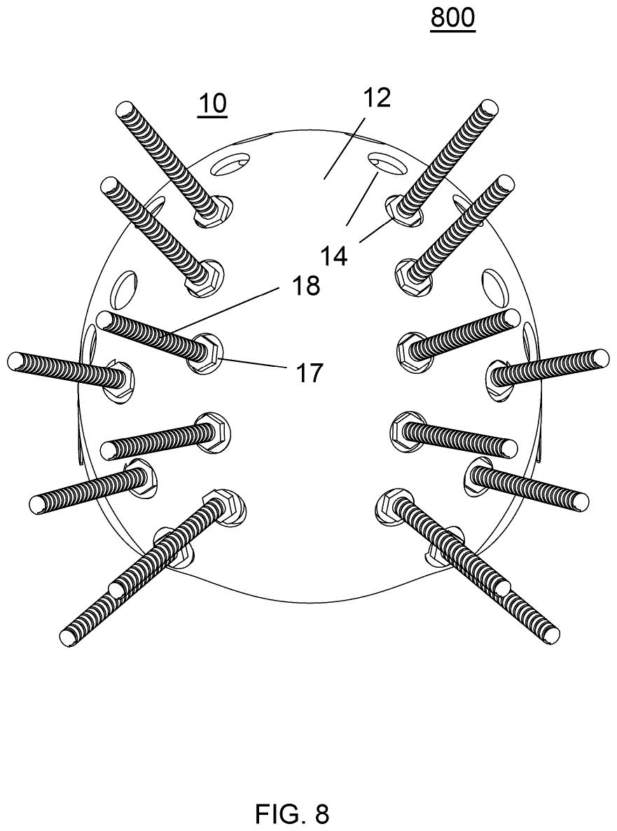

FIG. 8 is a top view 800 of an embodiment of the present disclosure.

Turning now to FIG. 8, a top view 800 of the helmet 10 (initially shown in FIG. 1) is provided, the helmet 10 including a head-conforming base 12 that rests comfortably on the patient's head. The helmet 10 has holes 14 through which nuts 17 and bolts 18 can be passed into the patient's scalp. All the holes 14 allow acupuncture treatment on the top of head area by being located in acupuncture points, hence heated nuts 17 and bolts 18 are able to pass through the holes 14 in order to directly be inserted into predetermined acupuncture points. The helmet 10 is further designed to be lightweight and comfortable for patients to wear. Discussion of all the relevant components 10, 12, 14 & 15 can also be found above for FIG. 2. The considerations and advantages of utilizing nuts 17 and bolts 18 for a non-needle based moxa treatment are also discussed above in the discussion for FIG. 7.

In FIG. 8, the top view 800 shows an exemplary pattern in which the holes 14 can be arranged in, but this arrangement is not limited to the arrangement that is shown in FIG. 8, and can be any desired arrangement, especially one that provides improved or optimal heat-based acupuncture treatment to patients. The top view 800 also shows some holes 14 without any nuts 17 or bolts 18 inserted within them, and some holes 14 with nuts 17 and bolts 18 inserted within them, and this is also a possible arrangement of the present disclosure, as demonstrated in FIG. 8.

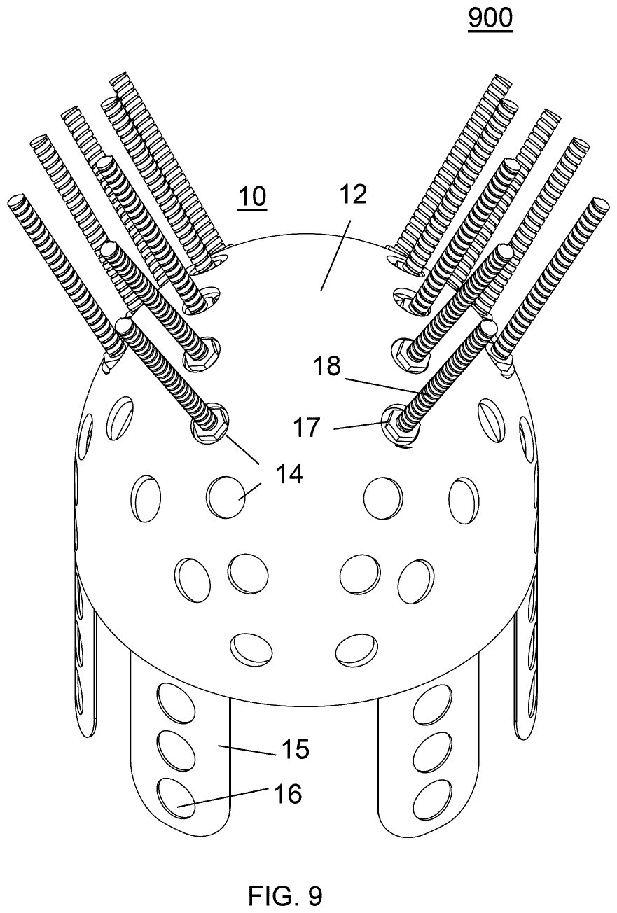

FIG. 9 is a rear view 900 of an embodiment of the present disclosure.

Turning now to FIG. 9, a rear view 900 of the helmet 10 (initially shown in FIG. 1) is provided, the helmet 10 including a head-conforming base 12 that rests comfortably on the patient's head. The helmet 10 has holes 14 through which nuts 17 and bolts 18 can be passed into the patient's scalp. All the holes 14 allow acupuncture treatment on the top of head area by being located in acupuncture points, hence heated nuts 17 and bolts 18 are able to pass through the holes 14 in order to directly be inserted into predetermined acupuncture points. The helmet 10 is further designed to be lightweight and comfortable for patients to wear. Moreover, similar to FIG. 2, flaps 15 and flap holes 16 are shown. Discussion of all the relevant components 10, 12, 14, 15 and 16 can also be found above for FIG. 2. The considerations and advantages of utilizing nuts 17 and bolts 18 for a non-needle based moxa treatment are also discussed above in the discussion for FIG. 7.

In FIG. 9, the rear view 900 shows an exemplary pattern in which the holes 14 can be arranged in, but this arrangement is not limited to the arrangement that is shown in FIG. 9, and can be any desired arrangement, especially one that provides improved or optimal heat-based acupuncture treatment to patients. The rear view 900 also shows some holes 14 without any nuts 17 or bolts 18 inserted within them, and some holes 14 with nuts 17 and bolts 18 inserted within them, and this is also a possible arrangement of the present disclosure, as demonstrated in FIG. 9.

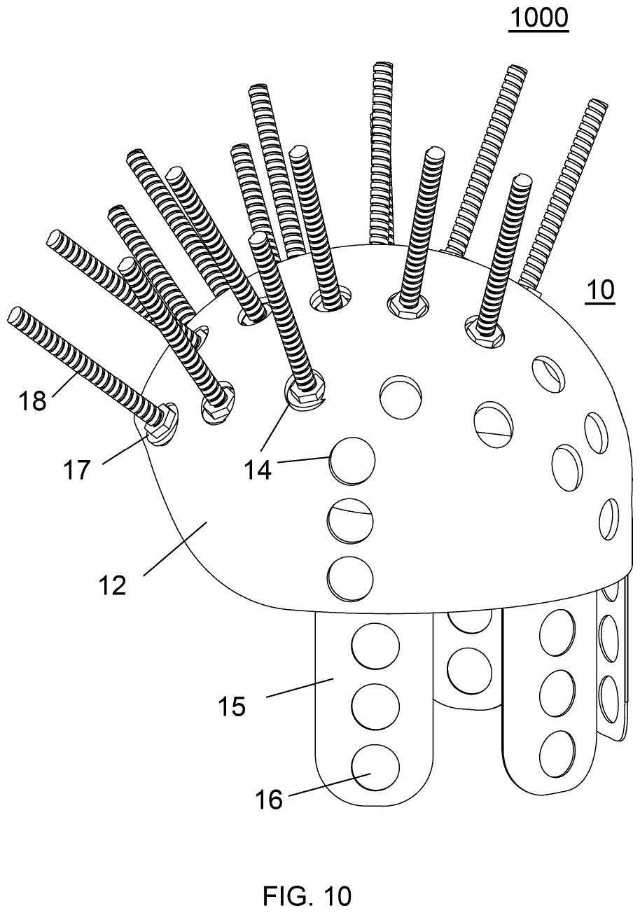

FIG. 10 is a left view 1000 of an embodiment of the present disclosure.

Turning now to FIG. 10, a left view 1000 of the helmet 10 (initially shown in FIG. 1) is provided, the helmet 10 including a head-conforming base 12 that rests comfortably on the patient's head. The helmet 10 has holes 14 through which nuts 17 and bolts 18 can be passed into the patient's scalp. All the holes 14 allow acupuncture treatment on the top of head area by being located in acupuncture points, hence heated nuts 17 and bolts 18 are able to pass through the holes 14 in order to directly be inserted into predetermined acupuncture points. The helmet 10 is further designed to be lightweight and comfortable for patients to wear. Moreover, similar to FIG. 2, flaps 15 and flap holes 16 are shown. Discussion of all the relevant components 10, 12, 14, 15 and 16 can also be found above for FIG. 2. The considerations and advantages of utilizing nuts 17 and bolts 18 for a non-needle based moxa treatment are also discussed above in the discussion for FIG. 7.

In FIG. 10, the left view 1000 shows an exemplary pattern in which the holes 14 can be arranged in, but this arrangement is not limited to the arrangement that is shown in FIG. 10, and can be any desired arrangement, especially one that provides improved or optimal heat-based acupuncture treatment to patients. The left view 1000 also shows some holes 14 without any nuts 17 or bolts 18 inserted within them, and some holes 14 with nuts 17 and bolts 18 inserted within them, and this is also a possible arrangement of the present disclosure, as demonstrated in FIG. 10.

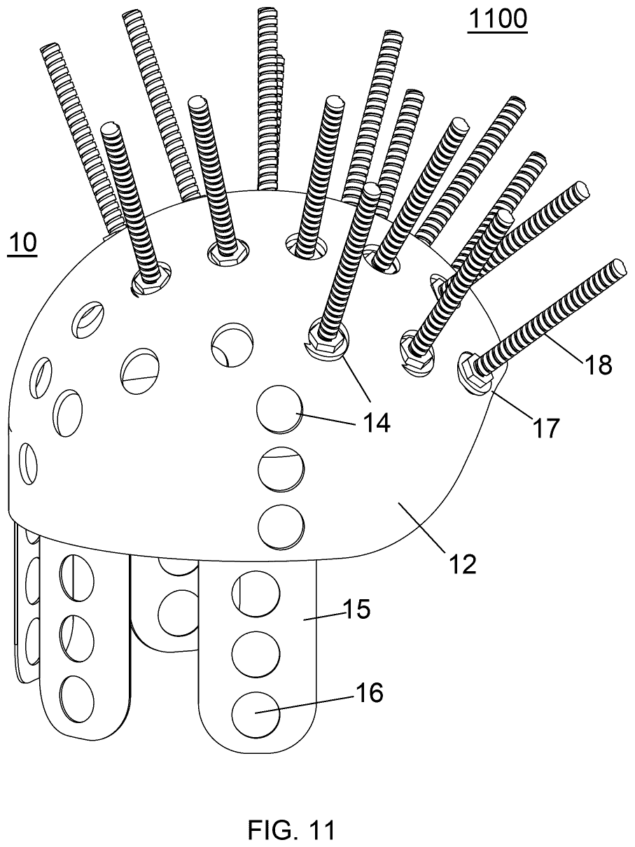

FIG. 11 is a right view 1100 of an embodiment of the present disclosure.

Turning now to FIG. 11, a right view 1100 of the helmet 10 (initially shown in FIG. 1) is provided, the helmet 10 including a head-conforming base 12 that rests comfortably on the patient's head. The helmet 10 has holes 14 through which nuts 17 and bolts 18 can be passed into the patient's scalp. All the holes 14 allow acupuncture treatment on the top of head area by being located in acupuncture points, hence heated nuts 17 and bolts 18 are able to pass through the holes 14 in order to directly be inserted into predetermined acupuncture points. The helmet 10 is further designed to be lightweight and comfortable for patients to wear. Moreover, similar to FIG. 2, flaps 15 and flap holes 16 are shown. Discussion of all the relevant components 10, 12, 14, 15 and 16 can also be found above for FIG. 2. The considerations and advantages of utilizing nuts 17 and bolts 18 for a non-needle based moxa treatment are also discussed above in the discussion for FIG. 7.

In FIG. 11, the right view 1100 shows an exemplary pattern in which the holes 14 can be arranged in, but this arrangement is not limited to the arrangement that is shown in FIG. 11, and can be any desired arrangement, especially one that provides improved or optimal heat-based acupuncture treatment to patients. The right view 1100 also shows some holes 14 without any nuts 17 or bolts 18 inserted within them, and some holes 14 with nuts 17 and bolts 18 inserted within them, and this is also a possible arrangement of the present disclosure, as demonstrated in FIG. 11.

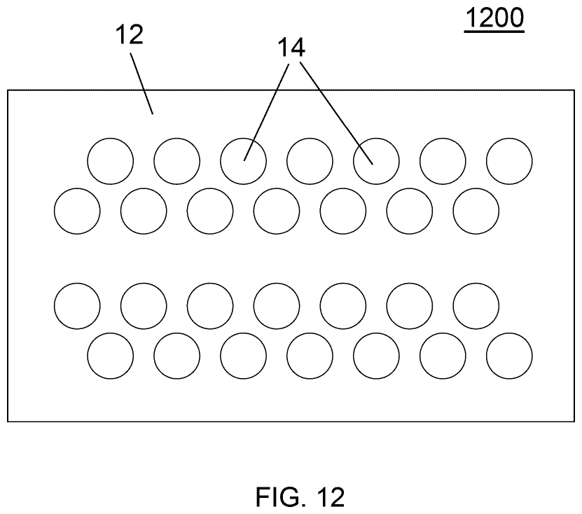

FIG. 12 is a top view 1200 of an embodiment of the present disclosure with particular dimensions.

In FIG. 12, the top view 1200 illustrates an example or exemplary configuration of the holes 14 within the base 12 (or head-conforming base 12) of the helmet 10 (shown in FIGS. 1-11 but not shown here because this is a blown-up portion of the helmet focusing on the base 12). As can be seen in the top view 1200 of FIG. 12, the holes 14 are arranged in an alternating zig-zag like pattern. However, the arrangement of the holes 14 is not limited to this arrangement, and can be any desired arrangement, especially one that provides improved or optimal heat-based acupuncture treatment to patients.

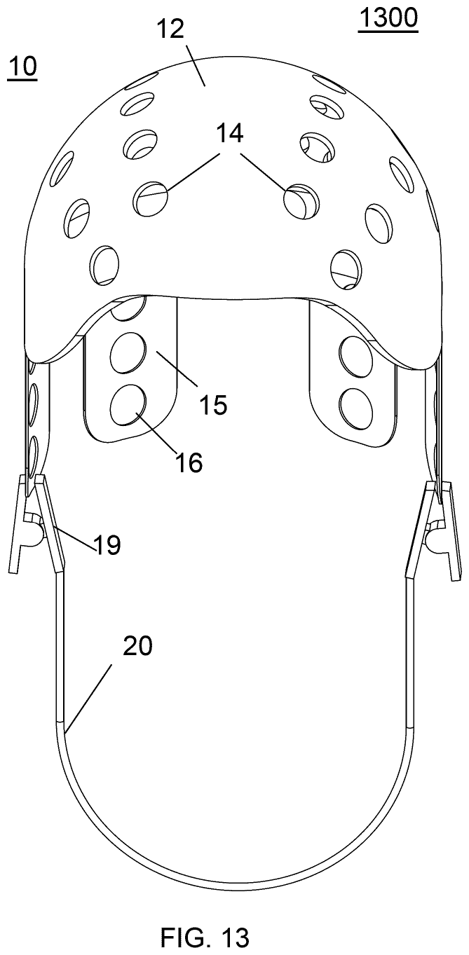

FIG. 13 is a front view 1300 of an embodiment of the present disclosure showing an extended helmet.

Turning now to FIG. 13, a front view 1300 of the helmet 10 (initially shown in FIG. 1) is provided, the helmet 10 including a head-conforming base 12 that rests comfortably on the patient's head. The helmet 10 has holes 14 through which needles 13 (shown in FIG. 1) or nuts 17 and bolts 18 (shown in FIGS. 7-11) can be passed into the patient's scalp. All the holes 14 allow acupuncture treatment on the top of head area by being located in acupuncture points, hence heated needles 13, nuts 17 and bolts 18 are able to pass through the holes 14 in order to directly be inserted into predetermined acupuncture points. The helmet 10 is further designed to be lightweight and comfortable for patients to wear. Moreover, similar to FIG. 2, flaps 15 and flap holes 16 are shown. Discussion of all the relevant components 10, 12, 14, 15 and 16 can also be found above for FIG. 2. The considerations and advantages of utilizing nuts 17 and bolts 18 for a non-needle based moxa treatment are also discussed above in the discussion for FIG. 7. Finally, the new components shown in FIG. 13 are clamp 19 and the strap 20, which are used to provide a better fit of the helmet 10 on the patient's head, and to customize the fit, which can be adjusted.

The clamp 19 and the strap 20 shown can take a variety of different forms and is not limited to the specific forms shown above. For example, clamp 19 can be a binder clip, a fastener, a loop, a connector, a zipper, a Velcro attachment, or any other similar component. Strap 20 can also be a wire, rope, strand of flexible or elastic material, and be made of material including nylon, polyester, polypropylene, elastic, thread and other similar materials.

In FIG. 13, the front view 1300 shows an exemplary pattern in which the holes 14 can be arranged in, but this arrangement is not limited to the arrangement that is shown in FIG. 13, and can be any desired arrangement, especially one that provides improved or optimal heat-based acupuncture treatment to patients.

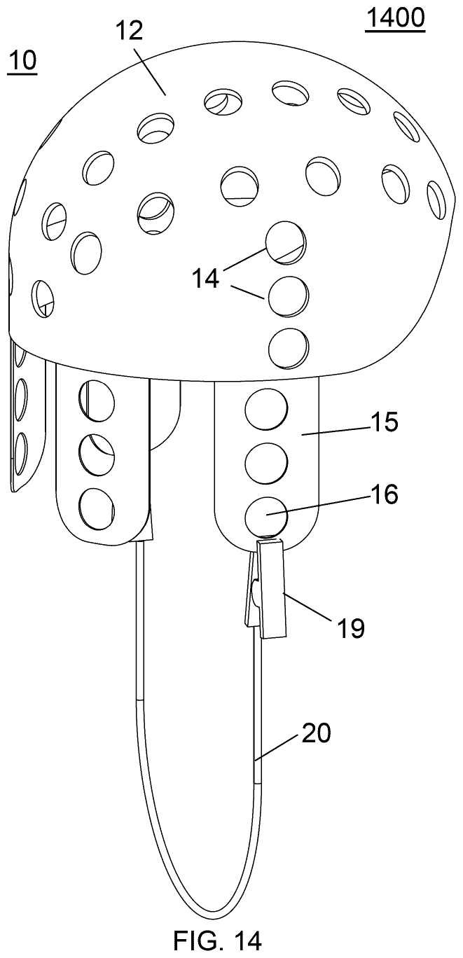

FIG. 14 is a side view 1400 of an embodiment of the present disclosure showing an extended helmet.

Turning now to FIG. 14, a side view 1400 of the helmet 10 (initially shown in FIG. 1) is provided, the helmet 10 including a head-conforming base 12 that rests comfortably on the patient's head. The helmet 10 has holes 14 through which needles 13 (shown in FIG. 1) or nuts 17 and bolts 18 (shown in FIGS. 7-11) can be passed into the patient's scalp. All the holes 14 allow acupuncture treatment on the top of head area by being located in acupuncture points, hence heated needles 13, nuts 17 and bolts 18 are able to pass through the holes 14 in order to directly be inserted into predetermined acupuncture points. The helmet 10 is further designed to be lightweight and comfortable for patients to wear. Moreover, similar to FIG. 2, flaps 15 and flap holes 16 are shown. Discussion of all the relevant components 10, 12, 14, 15 and 16 can also be found above for FIG. 2. The considerations and advantages of utilizing nuts 17 and bolts 18 for a non-needle based moxa treatment are also discussed above in the discussion for FIG. 7. Finally, the clamp 19 and the strap 20 are described for FIG. 13 above, which are used to provide a better fit of the helmet 10 on the patient's head, and to customize the fit, which can be adjusted.

The clamp 19 and the strap 20 shown can take a variety of different forms and is not limited to the specific forms shown above. For example, clamp 19 can be a fastener, a loop, a connector, a zipper, a Velcro attachment, or any other similar component. Strap 20 can also be a wire, rope, strand of material, and be made of material including nylon, polyester, polypropylene, elastic, thread and other similar materials.

In FIG. 14, the side view 1400 shows an exemplary pattern in which the holes 14 can be arranged in, but this arrangement is not limited to the arrangement that is shown in FIG. 13, and can be any desired arrangement, especially one that provides improved or optimal heat-based acupuncture treatment to patients.

One preferred pattern for the holes is shown above for FIGS. 1-14 with holes 14 along the top and sides. However, these patterns may be varied depending on the needs of the acupuncturest consistent with the present disclosure. In some embodiments, the base 12 may also include openings (not shown) on each side of the helmet 10 to allow for the connection of a chin strap for securing the helmet 10 on the patient's head—an example of this is the configuration shown in FIGS. 13-14.

In the present disclosure, the patient wears the helmet 10 in a manner that base 12 covers the head area. Multiple needles 13 (or nuts 17 and bolts 18) are then inserted through the holes 14 in the helmet 10 into the skin top outermost area layer but do not actually penetrate the cranium, according to the preferred technique of the acupuncturest. The needles (or nuts and bolts) may then be warmed multiple times with the hair dryer on heat mode or any of the other disclosed heat sources 11 above,. In some embodiments, the needles may be warmed with a smaller sized hair dryer on heat mode. The acupuncturest should monitor the patient for any signs of discomfort. The base 12 is also made from a durable material that effectively shields the patient's hair and scalp from the heat generated during the acupuncture treatment. After treatment, the helmet 10 is removed from the patient's head.

The present disclosure allows for safe and effective heat-based acupuncture treatments. This ensures a safe and comfortable experience for both the practitioner and the patient. The helmet 10 of the present invention improves patient comfort and practitioner confidence by enhancing the safety profile of traditional acupuncture techniques. The helmet 10 also allows for a more controlled and precise application of heat and opens new possibilities for the use of heat acupuncture on the head.

The helmet 10 also provides the following advantages: (1) Enhanced safety: The helmet significantly ensures greater safety for both the patient and the practitioner. (2) Improved comfort: The helmet reduces the patient's anxiety and discomfort associated with hair scattered by wind. (3) Versatility: The helmet can be adapted for use with various hot air acupuncture techniques. (4) Simple and effective design: The helmet is easy to use and clean, making it a practical and convenient solution for acupuncture practitioners.

The present disclosure provides a valuable tool for acupuncture practitioners who wish to perform beat acupuncture on the head safely and effectively. By significantly reducing the risk of hair scattered by wind, this invention enhances patient safety and comfort, making it a valuable addition to the field of acupuncture therapy.

According to one aspect of the present disclosure, the helmet may be one of two types: (1) A helmet implementing nuts and bolts (as shown in FIGS. 7-11), that utilizes nuts and bolts inserted into small holes with air inserted into the holes for moxa treatment, or Moxibustion-and the screw sets (including nuts and bolts or a screw set including a nut and a bolt) can be heated up with a heat source such as a hairdryer; and (2) A helmet implementing needles or acupuncture needles inserted into bigger holes, and then the needles are heated up using a heat source such as a hairdryer, which may be another version of moxa treatment or Moxibustion.

For both types of helmets, a modified design can be provided to cover the ears of the patient by adding a component made up of the same material as the base or helmet. This ear cover-up design can prevent excessive heat from flowing to the ears of the patient.

According to an aspect of the present disclosure, one of indirect moxa methods that can be utilized will have 34 holes and also two small slits on the top of head. These two slits are also “T-shaped” and provide ventilation to the patient. The slits made be made of the same material as the base and helmet are made of, as disclosed above.

An advantage of the present disclosure is the helmet's ability to affect the designated acupuncture channel and brain function to enhance internal organ functions as well as external muscular-skeletal and nerve system functionality as well.

According to an aspect of the present disclosure, and for the first type of helmet discussed above using nuts and bolts, the bolt's head can be inside the helmet and the nut can be outside helmet for the most secure configuration.

The novelty and non-obviousness of the present disclosure included providing a moxa treatment with a helmet-embedded screw system for acupoint stimulation. This integration also offers a unique and potentially groundbreaking approach to pain management.

Moreover, safety concerns can be observed for patients that are scared of traditional needles, and the present disclosure can be used for minor children and even animals like dogs, cats and other pets.

In addition, the moxa or Moxibustion treatment aspects of the helmet using screw sets (a screw set including a nut and a bolt) incorporates details of a helmet-embedded screw system into a moxa treatment framework.

A or several processors may be utilized in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

For a firmware and/or software implementation, the methodologies may be implemented with modules (e.g., procedures, functions, and so on) that perform the functions described herein. A machine-readable medium tangibly embodying instructions may be used in implementing the methodologies described herein. For example, software codes may be stored in a memory and executed by a processor unit. Memory may be implemented within the processor unit or external to the processor unit. As used herein, the term “memory” refers to types of long term, short term, volatile, nonvolatile, or other memory and is not to be limited to a particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be an available medium that can be accessed by a computer. By way of example, and not limitation, such computer-readable media can include RAM, ROM, EEPROM, CD-ROM or other optical disk storage, magnetic disk storage or other magnetic storage devices, or other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the technology of the disclosure as defined by the appended claims. For example, relational terms, such as “above” and “below” are used with respect to a substrate or electronic device. Of course, if the substrate or electronic device is inverted, above becomes below, and vice versa. Additionally, if oriented sideways, above and below may refer to sides of a substrate or electronic device. Moreover, the scope of the present application is not intended to be limited to the particular configurations of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding configurations described herein may be utilized according to the present disclosure. Accordingly, the appended claims are intended to include within their scope such processes, machines, manufacture, compositions of matter, means, methods, or steps.

What is claimed is:

1. A system used for acupuncture treatment, comprising:
a helmet comprising:
a base having at least one hole positioned at strategically designated acupuncture points;
at least one object placed within the at least one hole; and
a heat source, wherein the heat source is configured to heat up the at least one object for acupuncture treatment.

2. The system of claim 1, wherein material making up the base comprises aluminum, copper, silver, gold, plastic, silicone, thermoplastics, fiberglass, Kevlar, carbon fiber, composite blends of these prior listed materials and other similar materials.

3. The system of claim 1, wherein the at least one object is at least one acupuncture needle, and wherein the at least one acupuncture needle is made up of material comprising thermoplastics, plastics, metal, carbon fiber, composite blends of these prior listed materials and other similar materials, and further wherein the surface of the at least one acupuncture needle is coated in silicone.

4. The system of claim 1, wherein the heat source comprises a portable hair dryer, a standing hair dryer, a professional hooded floor hair dryer, a laser, a stationary heat lamp, a portable electric or battery generated heat lamp.

5. The system of claim 1, wherein the at least one object comprises at least one screw set, each screw set of the at least one screw set comprising: a nut and a bolt.

6. The system of claim 5, wherein the nut and the bolt are made of materials comprising plastic, polymer, PEEK (polyetheretherketone), steel, titanium and other similar bio-compatible materials.

7. The system of claim 5, wherein the helmet, the at least one hole and the at least one screw set are used to perform a Moxibustion treatment process.

8. The system of claim 7, wherein the helmet, the at least one hole and the at least one screw set are used to specifically target conditions comprising headaches, migraines, neck pain and other similar symptoms.

9. The system of claim 1, further comprising:
a pair of clamps coupled to opposite sides of the helmet; and
a strap that is coupled to the pair of clamps.

10. The system of claim 9, wherein the pair of clamps comprises a binder clip, a fastener, a loop, a connector, a zipper, a Velcro attachment, or any other similar component.

11. The system of claim 9, wherein the strap comprises a wire, a rope, a strand of flexible or elastic material, and be made of material including nylon, polyester, polypropylene, elastic, thread and other similar materials.

12. The system of claim 9, wherein the pair of clamps and the strap can be adjusted so as to provide better fit for the helmet.

13. A method for acupuncture treatment comprising:
configuring at least one strategically placed hole in a helmet according to specific acupuncture points;
having a patient wear the helmet snugly;
inserting at least one object into the at least one strategically placed hole;
heating up the at least one object with a heat source; and
administering heat-based acupuncture treatment to the patient via the heated up at least one object through the at least one strategically placed hole.

14. The method of claim 13, wherein having the patient wear the helmet snugly comprises:
fitting around the lower portion of the patient's head above a neck region, a clamp and a strap; and
adjusting the clamp and the strap so that a snug fit around the patient's head is achieved.

15. The method of claim 13, wherein the at least one object comprises at least one acupuncture needle, and wherein the at least one acupuncture needle is made up of material comprising thermoplastics, plastics, metal, carbon fiber, composite blends of these prior listed materials and other similar materials, and further wherein the surface of the at least one acupuncture needle is coated in silicone.

16. The method of claim 13, wherein the at least one object comprises at least one screw set, each screw set of the at least one screw set comprising: a nut and a bolt.

17. The method of claim 16, wherein the nut and the bolt are made of materials comprising plastic, polymer, PEEK (polyetheretherketone), steel, titanium and other similar bio-compatible materials.

18. The method of claim 16, wherein the heat-based acupuncture treatment comprises a Moxibustion treatment process.

19. The method of claim 16, wherein the Moxibustion treatment process is configured to specifically target conditions comprising headaches, migraines, neck pain and other similar symptoms.

20. The method of claim 16, wherein the heat source comprises a portable hair dryer, a standing hair dryer, a professional hooded floor hair dryer, a laser, a stationary heat lamp, a portable electric or battery generated heat lamp
